(19) United States
(12) Patent Application Publication
(10) Pub. No.: US 2025/0023314 A1
(43) Pub. Date: Jan. 16, 2025

(54) SPATIALLY HOMOGENEOUS NONLINEAR SPECTRAL BROADENING

(71) Applicant: Lawrence Livermore National Security, LLC, Livermore, CA (US)

(72) Inventor: Issa F. Tamer, Livermore, CA (US)

(21) Appl. No.: 18/711,856

(22) PCT Filed: Dec. 1, 2021
(86) PCT No.: PCT/US2021/072670

§ 371 Date: May 20, 2024

(51) Int. Cl. H01S 3/00

(52) U.S. Cl. CPC H01S 3/0057; H01S 3/0092

(57) ABSTRACT

An optical device provides nonlinear spectral broadening of laser pulses of a laser beam having a spatially varying intensity profile. The device comprises a nonlinear optical element and an optical path difference compensator. The nonlinear optical element has a spatially varying thickness that depends on the spatially varying intensity profile of the laser beam. The optical path difference compensator has a spatially varying thickness that varies such that the optical path length over which the laser beam propagates through the nonlinear optical element and the compensator is spatially more uniform across most of the laser beam cross-section.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### BACKGROUND

### Field

The present disclosure relates generally to spatially homogeneous nonlinear spectral broadening such as homogenous nonlinear spectral broadening for ultrashort laser pulse compression.

### Description of the Related Art

Scaling state of the art laser systems towards higher peak powers can be a costly, time-intensive, and difficult endeavor. One option for obtaining higher peak power is via chirped pulse amplification (CPA). A laser pulse is propagated through a stretcher such that certain frequencies are delayed with respect to other frequencies. Consequently, the pulse is broadened, that is, the pulse extends over a longer duration in time and the amplitude is reduced. This broadened pulse may be amplified thereby increasing the peak intensity of the laser pulse. A compressor may then shorten the duration of the pulse thereby further increasing the peak intensity. For some CPA systems, the compressor comprises, for example, a pair of diffraction gratings or prisms that superimposes wavelengths that were initially spread out over time such that the pulse has a shorter temporal duration. In many cases, however, the pulse duration has been optimized near the shortest possible value set by the design of the CPA system. What is needed are ways to further compress the pulse and increase the intensity of the laser pulse output by the CPA system.

### SUMMARY

Various designs disclosed herein, however, allow for a significant reduction in laser pulse duration beyond the conventional CPA-limited value, resulting in a direct (e.g., 2-3×) increase in the peak power with negligible energy loss, high repetition operation, and adaptability for real (i.e., inhomogeneous) laser beam profiles. The set-up that provides such features may also be compact and aperture-scalable. Various systems or sub-systems disclosed herein for post-CPA pulse compression comprise, for example, a single shaped plastic for strong, uniform nonlinear spectral broadening, a spatio-temporal corrector plate, and a mirror, followed by a bulk plate or chirped mirror pair compressor. Such a system or sub-system can be integrated with any high peak power laser system, even ones that employ CPA, without modifying the existing CPA chain. Successful implementation of such systems and/or sub-systems can potentially provide the end-user with an inexpensive, efficient method to shorten the pulse duration, scale the peak power, and possibly enable advanced experimental capabilities (e.g., laser-driven wakefield acceleration) for current and next-generation laser systems.

Accordingly, various devices, systems and methods described herein include nonlinear optical elements configured to address spatial non-uniformity in a laser beam that can inhibit pulse compression employing nonlinear spectral broadening. These solutions provide for spatially homogenous nonlinear optical spectral broadening, which then allows for increased pulse compression.

Various implementations described herein, for example, include an optical device that provides nonlinear spectral broadening of laser pulses output by a laser source. The laser source is configured to output a laser beam that propagates in a longitudinal direction and has a spatially varying intensity profile across a cross-section of the laser beam orthogonal to the longitudinal direction. The optical device comprises a nonlinear optical element and an optical path difference compensator. The nonlinear optical element comprises a layer of material that has a nonlinear index of refraction at the intensity of the laser beam. The layer of material having a nonlinear index of refraction has a spatially varying thickness that depends on the spatially varying intensity profile of the laser beam. The optical path difference compensator comprises a layer of material having a spatially varying thickness that varies to at least partially compensate for at least some of the spatially varying optical path length of said at least on nonlinear optical element. In some implementations, the layer of material comprising the optical compensator has a spatially varying thickness that varies such that the optical path length (the product of the physical distance and the index of refraction over that distance), over which the laser beam propagates through the nonlinear optical element and the compensator, is spatially more uniform across most of the cross-section of the laser beam.

In various implementations described herein, the optical path difference compensator corrects for the spatially varying group delay and, in some cases, the spatially varying dispersion, induced by the spatially varying nonlinear element.

In certain implementations, the laser source comprises a chirped pulse amplification (CPA) system. The optical device may be used in combination with a pulse compressor. The pulse compressor may be disposed to receive the laser beam after passing through the nonlinear optical element and the optical path difference compensator and may further compress the laser pulses output by the CPA system. In some implementations, the laser source operates at a wavelength wherein the nonlinear optical element has negative or anomalous dispersion that provides pulse compression (e.g., instead of using a separate compressor such as a chirped mirror pair downstream of the nonlinear optical element).

A wide variety of other devices, subsystems and systems are disclosed herein. For example, although some devices may include only a single nonlinear optical element and only a single OPD compensator, other devices may comprise more than one nonlinear optical element or more than one OPD compensator or more than one nonlinear optical element and more than one OPD compensator. Similarly, more than one layer of material having a nonlinear refractive index may be included in a nonlinear optical element. Likewise, more than one layer of optically transmissive material may be included in an OPD compensator. Different nonlinear optical elements in the device can comprise the same or different material having the same or different refractive indices. The different layers of material having a nonlinear refractive index can comprise the same or different material having the same or different refractive indices. Different OPD compensators in the device can comprise the same or different material having the same or different refractive indices. The different layers of optically transmissive material can comprise the same or different material having the same or different refractive indices as well. Additionally, one or more additional layers of material that have a non-linear refractive index and/or one or more additional layers of optically transmissive material may be included in the device, the thickness of which can be varying or non-varying. Accordingly, any of the features, characteristics, properties, arrangements, and/or designs of the nonlinear optical element and/or OPD compensator described herein may be applicable to multiple nonlinear optical elements and/or multiple OPD compensators as well as possibly to one or more additional layers of material that have a non-linear refractive index and/or one or more additional layers of optically transmissive material that may be included in the device.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a block diagram of an example chirped pulse amplification (CPA) system.

FIG. 2A is a schematic drawing illustrating a laser beam having a Gaussian intensity distribution incident on a nonlinear optical element that exhibits self-phase modulation at the intensity level of the laser beam and the resultant spatially inhomogeneous spectral broadening induced by the nonlinear optical element.

FIG. 2B are schematic plots of intensity versus time showing the laser pulse incident on the nonlinear optical element and a laser pulse output from a pulse compressor disposed to receive the laser light from the nonlinear optical element. The laser pulse output from the pulse compressor has reduced compression and peak intensity as a result of the spatially inhomogeneous spectral broadening produced by the nonlinear optical element.

FIG. 2C is a schematic spatio-temporal plot showing spatial variation in the temporal intensity profile (e.g., spatial variation in the compressed pulse duration across the cross-section of the laser beam) caused by the spatially inhomogeneous spectral broadening introduced by the nonlinear optical element.

FIG. 3 is a schematic drawing illustrating a laser beam having a Gaussian intensity distribution incident on an optical path difference compensator and a nonlinear optical element having a thickness profile that changes in accordance with the Gaussian intensity distribution of the laser beam and the resultant spatially homogeneous spectral broadening at the output of the nonlinear optical element.

FIG. 4 is a schematic cross-sectional view of an optical path difference compensator and a nonlinear optical element having a thickness profile that changes in accordance with the intensity profile of a laser beam having a spatially varying intensity distribution incident thereon such as shown in FIG. 3. The optical path difference compensator and nonlinear optical element fit together and are in contact with each other.

FIGS. 5A and 5B are schematic drawings illustrating side and front views of the nonlinear optical element shown in FIG. 4.

FIGS. 6A and 6B are schematic drawings illustrating side and front views of the optical path different compensator shown in FIG. 4.

FIG. 7A is a schematic drawing illustrating a laser beam having a Gaussian intensity distribution incident on a device comprising an optical path difference compensator, a nonlinear optical element, and a face-cooled mirror and the resultant spatially homogeneous spectral broadening output by the device.

FIG. 7B are schematic plots of intensity versus time showing the laser pulse incident on the optical path difference compensator, nonlinear optical element, and face-cooled mirror and the laser pulse output from a pulse compressor disposed to receive the light after having passed (twice) through the nonlinear optical element and the optical path difference compensator showing the increased compression and peak intensity.

FIG. 7C is a schematic spatio-temporal plot showing spatial homogeneity in the temporal intensity profile (e.g., the lack of spatial variation in the compressed pulse duration across the cross-section of the laser beam) after having passed through the nonlinear optical element and the optical path difference compensator.

FIG. 8 is a schematic drawing of a laser beam propagating through a system comprising an optical path difference compensator, a nonlinear optical element having a thickness profile that changes in accordance with the intensity profile of the laser beam, and a compressor comprising a pair of chirped mirrors. A laser pulse at the output is compressed and has a shorter duration and higher peak intensity than a laser pulse at the input.

FIG. 9 is a schematic drawing of a laser beam propagating through a system comprising an optical path difference compensator, a nonlinear optical element having a thickness profile that changes in accordance with the intensity profile of the laser beam, and a compressor comprising a pair of chirped mirrors. The system further comprises a face-cooled mirror to reduce heating possibly for high average power operation. A laser pulse at the output is compressed and has a shorter duration and higher peak intensity than a laser pulse at the input.

FIG. 10 is a schematic drawing of a laser beam propagating through a system comprising an optical path difference compensator and a nonlinear optical element having a thickness profile that changes in accordance with the intensity profile of the laser beam. The laser beam comprises wavelengths in a range wherein the nonlinear optical element and optical path difference compensator have negative dispersion so as to provide pulse compression (without an additional pulse compressor downstream of the nonlinear optical element/compensator pair). Accordingly, a pulse at the output of the nonlinear optical element/compensator combination is compressed and has a shorter duration and higher peak intensity than a pulse at the input.

### DETAILED DESCRIPTION

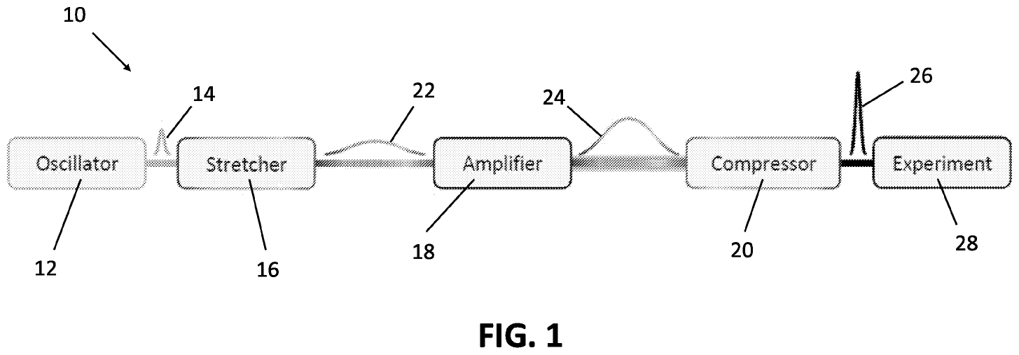

Various methods, designs and configurations discussed herein have the potential of directly addressing the peak power scaling concerns of existing and next-generation high power lasers. As discussed above, one option for obtaining higher peak power is via chirped pulse amplification (CPA). An example CPA system 10 is shown in FIG. 1. The CPA system 10 shows an oscillator 12, which may provide a laser pulse 14 to be amplified and further compressed. The CPA system 10 comprises a pulse stretcher 16 possibly comprising a grating or prism pair, an optical amplifier 18 and a pulse compressor 20 comprising, for example, a compensating grating pair. The laser pulse 14 is propagated through the grating or prism pair comprising the stretcher 16 such that certain frequencies of the optical pulse are delayed with respect to other frequencies. Consequently, the pulse 22 is stretched, that is, the pulse extends over a longer duration in time and the amplitude is reduced as optical energy is distributed over a longer time. This stretched pulse 22 may be amplified thereby increasing the peak intensity of the laser pulse as depicted by the amplified pulse 24 output from the amplifier. The compressor 20 subsequently shortens the duration of the pulse 26 thereby further increasing the peak intensity. For some CPA systems 10, the compressor 20 comprises, for example, a chirp mirror pair or a pair of reflective diffraction gratings used to superimpose wavelengths that were initially spread out over time by the gratings in the stretcher 16 such that the pulse 26 has a shorter temporal duration. The compressed pulse 26 is shown directed into an experiment 28, however, the laser beam may be directed to other apparatus, samples, etc., depending on the application.

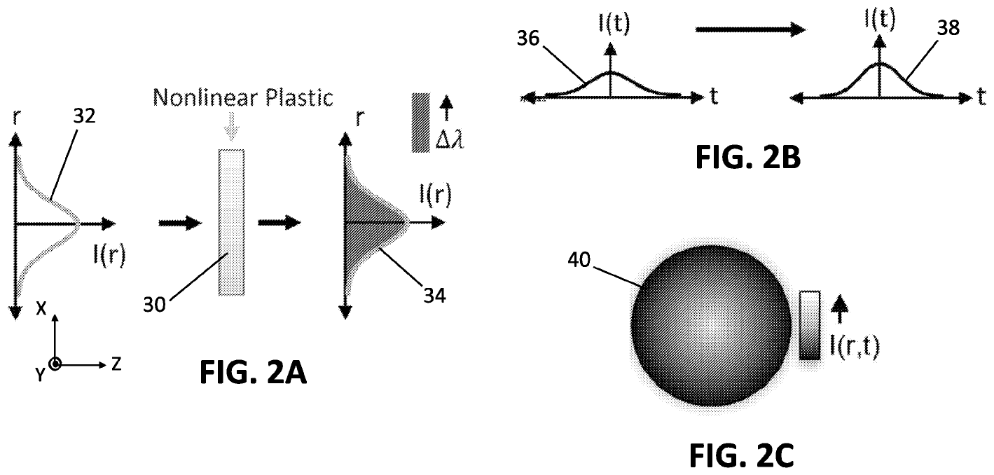

One possible approach for further compressing the pulse 26 output by the CPA system 10 is to provide additional bandwidth, often via a nonlinear process, to allow for subsequent compression. The pulse 26 output from the CPA system 10 can be directed through a nonlinear medium 30, such as the one shown in FIG. 2A, which is placed downstream of the CPA system. Such a nonlinear medium 30 may add additional spectral components or wavelengths within the laser pulse 26. Having a short pulse duration after compression is dependent on the number of optical frequencies present within the pulse. The nonlinear optical element 30 has the feature of modulating the instantaneous phase of the pulse to produce new optical frequencies and, therefore, broaden the spectrum within the pulse, thereby allowing for compression to shorter pulse durations. The transport intensities of high peak power laser pulses (e.g., 1-2 TW/cm²), for example, output by the CPA system, are sufficiently high to enable strong responses, such as self-phase modulation, in nonlinear materials. Such self-phase modulation (SPM) can be used for spectral broadening in near field, e.g., by placing the nonlinear optical element in the path of the high intensity beam without focusing the beam on the element. An example post-CPA pulse compression device may comprise, for example, a 1 mm thick piece of allyl diglycol carbonate (CR39), a nonlinear plastic that is highly transmissive (e.g., at about 700-1100 nm), and a chirped mirror pair to triple the peak power of a mJ-class, ultrashort laser pulse in a single-pass. The CR39 is a material having optical nonlinearities that provide a nonlinear broadening mechanism, while the chirped mirror pair can compress the pulse by manipulating the different spectral components. Applying such a technique to further compress a pulse from an energetic, high peak power laser system, however, may encounter difficulties due to the sensitivity of the nonlinear process to beam profile inhomogeneities and thermal effects. Many lasers output laser beams having spatially varying intensities. For example, many lasers output Gaussian beams having a Gaussian spatial distribution 32 such as shown in FIG. 2A. In particular, FIG. 2A shows a plot 32 of intensity versus radial distance from the center of the laser beam. This plot 32 has a Gaussian shape. The intensity is measured across a cross-section of the laser beam orthogonal to its length or longitudinal propagation direction. FIG. 2A shows, for example, an xyz coordinate system wherein the beam is shown propagating parallel to the z-direction. A cross-section of the beam orthogonal to its length may, for example, be parallel to the xy plane. As shown, the peak of the Gaussian distribution is at the center of the cross-section of the laser beam with “r” representing distance from this center or central axis of the beam. The profile shown in FIG. 2A is rotationally symmetric about the center and/or central axis of the laser beam. As illustrated, the intensity varies with spatial location, falling off with distance from the center/central axis. Although a Gaussian distribution is used as an example, the laser source may output laser beams having intensity distributions other than Gaussian. Devices, systems, sub-systems, and methods described herein are equally applicable to Gaussian or non-Gaussian intensity distributions.

This spatial variation in the laser beam can cause spatial inhomogeneity in the nonlinear spectral broadening produced by self-phase modulation, which is intensity dependent. The sensitivity of the nonlinear process to beam profile inhomogencities are depicted in FIG. 2A, which shows an output spatial intensity distribution 34, where the number of optical frequencies or wavelengths is different at different spatial locations. For example, a larger broadening of the spectrum occurs closer to the center of the beam where the intensity is higher, while a smaller broadening of the spectrum occurs farther from the central axis of the laser beam where the intensity is lower. In this example, a Gaussian beam with higher intensity along the central axis of the beam generates stronger nonlinear response (e.g., self-phase modulation) in the center than at the edges of the beam. Such spatial inhomogeneities in the nonlinear effect, e.g., self-phase modulation, weaken the ability to provide the shortest achievable compressed pulse after transmission through the compressor, which may comprise, for example, a chirped mirror pair downstream. FIG. 2B, for example, shows schematic plots of intensity versus time that depict the laser pulse 36 incident on the nonlinear optical element 30 and the laser pulse 38 output from the pulse compressor (not shown) that received the laser pulse from the nonlinear optical element. The laser pulse 38 output from the pulse compressor exhibits less compression and corresponding peak intensity than would otherwise be possible without spatial inhomogencities in the spectral broadening provided by the nonlinear optical element. Spatial inhomogencities in the spectral broadening corresponding to having varying amounts of spectral components added to the beam at different locations across the laser beam cross-section yield different amounts of pulse duration for different locations across the laser beam cross-section. FIG. 2C, a schematic spatio-temporal plot 40, shows this spatial variation in temporal intensity profile or pulse duration for the laser light output by the nonlinear optical element 30 as a result of the spatially inhomogeneous spectral broadening of the laser pulse 32 caused by interaction of the spatially inhomogeneous laser beam intensity with the nonlinear optical element. As illustrated, the center of the beam exhibits a shorter pulse duration than the periphery of the beam, where the pulse duration increases with distance from the center. This effect is the result of having higher beam intensities at the center of the beam, which produce more spectral broadening and more frequency components, compared to the lower beam intensities on the edges of the beam, which produce less spectral broadening and less frequencies components. This variation in pulse duration across the laser beam cross-section illustrated by the spatio-temporal profile shown in FIG. 2C, limits that pulse duration of the pulse averaged across the beam cross-section as illustrated in the temporal profile shown in FIG. 2B.

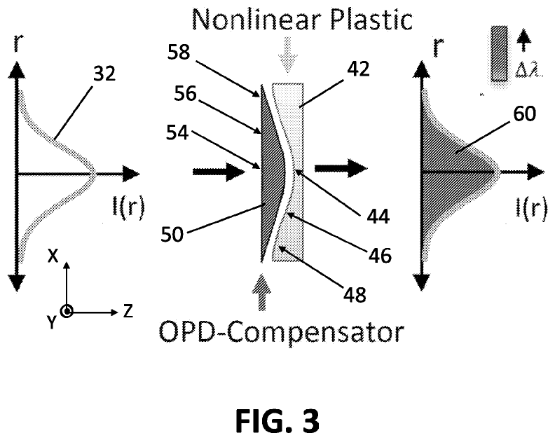

The solution to this issue, as shown in FIG. 3, is to utilize the laser beam spatial intensity profile 32 as a reference to shape a nonlinear optical element 42, which comprises a layer, e.g., sheet, film, plate, slab, etc. of material that exhibits a nonlinear variation in refractive index, n₂, with intensity of light incident thereon. The layer of nonlinear material is shaped to provide a spatially varying thickness that counters or reduces the spatially inhomogeneous nonlinear spectral broadening produced by the spatial varying intensity of the laser beam incident on the layer of nonlinear material.

An optical path difference compensator 50 comprising a shaped layer of highly transmissive material is additionally provided to offset the spatially varying phase shift produced by the shaped nonlinear optical element 42, which as described above has a spatially varying thickness. The optical path difference compensator 50 may comprise a layer of optically transmissive material through which the laser beam passes. This layer of optically transmissive material can be shaped to provide varying optical path length (e.g., the product of the distance and the index of refraction across that distance). The phase of the light passing through the layer of transmissive material in the optical path difference compensator 50 is determined at least in part by the optical path distance and likewise the thickness of this layer of transmissive material.

In various designs discussed herein, the thickness (e.g., parallel to the z direction and/or longitudinal direction of the laser beam) of the layer of nonlinear material comprising the nonlinear optical element 42 as well as of layer of optically transmissive material comprising the optical path difference compensator 50 are varied with respect to spatial location (e.g., in radial direction such as parallel to x or y directions) across the element. This variation in thickness across the nonlinear optical element 42 and the optical path difference compensator 50 is included at least in the region or portion of the optical element where the laser beam is incident. This variation in thickness is based on the variation in the intensity profile of the laser beam across its cross-section orthogonal to the beam propagation direction (e.g., which may be parallel to the z direction).

For example, as shown in FIG. 3, the nonlinear optical element 42 is thinner and possibly thinnest at the location 44 where the center of the laser beam is incident thereon to offset or counter the larger nonlinear effect induced by the higher optical intensity at the center of the laser beam for the Gaussian beam that is used in this example. As referenced above, a larger nonlinearity results from a larger intensity. Similarly, the nonlinear optical element 42 is thicker at the location 48, where the edges of the laser beam is incident thereon to offset or counter the reduced nonlinear effect produced by the lower optical intensity at the edge of the laser beam. At an intermediate radial location 46 between where the laser beams center and edges are incident, the thickness of the nonlinear optical element 42 may be larger than at the location 44 where the center of the laser beam is incident and smaller than at the location 48 where the edges of the laser beam are incident.

Likewise, in various implementations such as in the example shown in FIG. 3, the thickness of the nonlinear optical element 42 will increase from the location where the center 44 of the laser beam is incident thereon toward the locations 46, 48 away from the location where the center of the laser beam is incident thereon. In various implementations, therefore, the thickness profile of the nonlinear optical element 42 will vary, possibly increasing in thickness from a center point 44 thereon (e.g., along the x direction or y direction or any radial direction parallel to the xy plane shown in FIG. 3) toward other locations 46, 48 surrounding that center point. In some cases, this increase is monotonic. In some cases, the thickness profile and/or height of the surface of the nonlinear optical element is rotationally symmetric or strongly varying across its cross-section

This thickness variation with spatial position parallel to the xy plane can be configured to compensate for the variation in nonlinear optical effect produced by the varying intensity across the laser beam cross-section 32, which may be Gaussian. Accordingly, in some cases the thickness profile follows or is in accordance with and/or is based on a Gaussian profile, e.g., the thickness corresponds to a constant minus a Gaussian. Other shapes and configurations, however, are possible. In various implementations, to provide the varying thickness, the nonlinear optical element 42 has a concave surface on one side and a planar surface on the other side, although the nonlinear optical element can be configured differently (e.g., with shaped surfaces on both sides). As discussed above, a Gaussian distribution has been used for illustrative purpose, however, the intensity distribution of the laser beam may be different depending on the laser source, the application, etc. Accordingly, the spatially varying thickness of the layer of material having nonlinear refractive index in the nonlinear optical element vary differently across the width of the portion or region of the nonlinear optical element that receives the laser beam. For example, the laser beam may have a generally flat-top intensity distribution with one or more areas with increased and/or reduced intensity. Accordingly, the thickness profile and corresponding surface shapes for the layer of nonlinear material (e.g., plastic) comprising nonlinear optical element 42 may be different from the concave shape shown in FIG. 3.

The thickness variation of the nonlinear optical element 42, however, will introduce optical path differences (OPD) between different spatial locations across the nonlinear optical element. For example, the optical path length (e.g., the product of the physical length and the index of refraction) through the location 44 on the layer of nonlinear material where the center of the laser beam passes in FIG. 3 will be less than the optical path length through the location 48 where the edge of the laser beam passes. This optical path length difference between the two paths will introduce phase differences in light passing through the different spatial locations on the nonlinear optical element. Group delay, which is spatially varying, will therefore result.

To offset or counter this spatially varying group delay (phase), the optical path difference (OPD) compensator 50 is included in the path of the laser beam. This OPD compensator 50, likewise, also has a thickness (e.g., parallel to the z direction and/or longitudinal direction of the laser beam) that varies with spatial location (e.g., in radial direction such as parallel to x or y directions) across the element where the laser beam is incident based on the thickness of the nonlinear optical element 42 at the same spatial (e.g., radial) location. This thickness profile of the layer of optically transmissive material comprising the OPD compensator 50 therefore varies at least indirectly with the intensity profile of the laser beam across its cross-section orthogonal to the beam propagation direction (e.g., which may be parallel to the z direction) as the thickness of the nonlinear optical element also varies based on the intensity profile of the laser beam.

For example, as shown in FIG. 3, the layer of optically transmissive material comprising the OPD compensator 50 is thicker and possibly thickest at the location 54 where the center of the laser beam is incident thereon to offset or counter the effect of the thinner layer of nonlinear material along the path where the center of the laser beam passes through the nonlinear optical element 42. Likewise, the layer of optically transmissive material comprising the OPD compensator 50 is thinner and possibly thinnest at the location 58, where the edges of the laser beam is incident thereon to offset or counter the effect of the thicker layer of nonlinear material along the path where the edge of the laser beam passes through the nonlinear optical element 42. At a radial location 56 between where the laser beams center and edges are incident, the thickness of the layer of optically transmissive material comprising the OPD compensator 50 may be smaller than at the location 54 where the center of the laser beam is incident and larger than at the location where the edges 58 of the laser beam are incident.

Likewise, in various implementations such as the example shown in FIG. 3, the thickness of the OPD compensator 50 will decrease from the location 54 where the center of the laser beam is incident thereon toward the locations 56, 58 away from the location where the center of the laser beam is incident thereon. In various implementations, therefore, the thickness profile of the OPD compensator 50 will vary, possibly decreasing in thickness from a center point 54 thereon (e.g., along the x direction or y direction or any radial direction parallel to the xy plane shown in FIG. 3) toward the other locations 56, 58 surrounding that center point. In some cases, this decrease is monotonic. In some cases, the thickness profile and/or surface height of the layer of transmissive material comprising the OPD compensator 50 is rotationally symmetric or strongly varying across its cross-section.

This thickness can be configured to compensate for the optical path length variation in nonlinear optical element 42, which may be based on a Gaussian. Accordingly, in some cases the thickness profile of the OPD compensator 50 follows, is in accordance with, and/or is based on a Gaussian profile. The thickness of the layer of optically transmissive material or the height of the surface of the optically transmissive material comprising the OPD compensator may be Gaussian in some cases. Other shapes and configurations, however, are possible. In various implementations, to provide the varying thickness, the OPD compensator 50 has a concave surface on one side and a planar surface on the other side, although the OPD compensator can be configured differently (e.g., with shaped surfaces on both sides). As discussed above, laser sources and laser beams having intensity distributions other than Gaussian may be used. Accordingly, the shape of the nonlinear optical element 42 and the OPD compensator 50 may vary from that shown in FIG. 3 and discussed herein. For example, shapes other than the convex shape of the surface of the OPD compensator 50 shown in FIG. 3 may be used.

As discussed above, the OPD compensator 50 may have a spatially varying thickness profile that provides a spatially varying OPD that counters or at least partially compensates for or offsets the spatially varying OPD profile provided by the spatially varying thickness profile of the nonlinear optical element 42. Accordingly, the spatially varying thickness profile of the OPD compensator 50 may be such that the sum of the spatially varying thickness profile of the OPD compensator and the spatially varying OPD profile of the nonlinear optical element is constant over a spatial area comprising most of the cross-section of the laser beam. Similarly, the shape of the spatially varying thickness profile of the OPD compensator 50 may be such that the sum of the group delay through the OPD compensator and the nonlinear optical element 42 is constant over a spatial area comprising most of the cross-section of the laser beam. Spatially varying group delay across the cross-section of the laser beam may result in having portions of the pulse at different locations across the cross-section of the laser beam being delayed or phase shifted with respect to other portions of the pulse at other locations on the cross-section of the pulse. In various implementations, the shape the spatially varying thickness profile of the OPD compensator 50 may be such that such delay or phase shift is reduced for example to no more than a portion (e.g., 50%, 30%, 20%, 10%, 5%, or 1%) of the entire duration of the pulse.

The combination of the nonlinear optical element 42, which has a thickness profile to at least partially offset, counters, or compensates for the effect of the spatially varying intensity on the optical nonlinearity medium and the OPD compensator 50, which has a thickness profile to counter, at least partially offset or compensate for the varying OPD of the nonlinear optical element, together produce a laser beam output therefrom with a more spatially homogeneous optical bandwidth and phase, OPD, or group delay. This more spatially homogenous spectral broadening and optical bandwidth is schematically illustrated by the intensity versus radial distance plot 60 shown in FIG. 3 at the output of the combination of the nonlinear optical element and OPD compensator. The shading is the same under the plot 60, which according to the legend labelled Δλ, means that the different radial locations across the laser beam have the same number of spectral components added by the nonlinear optical element, and, thus, the spectral broadening or spectral bandwidth is the same across the cross-section.

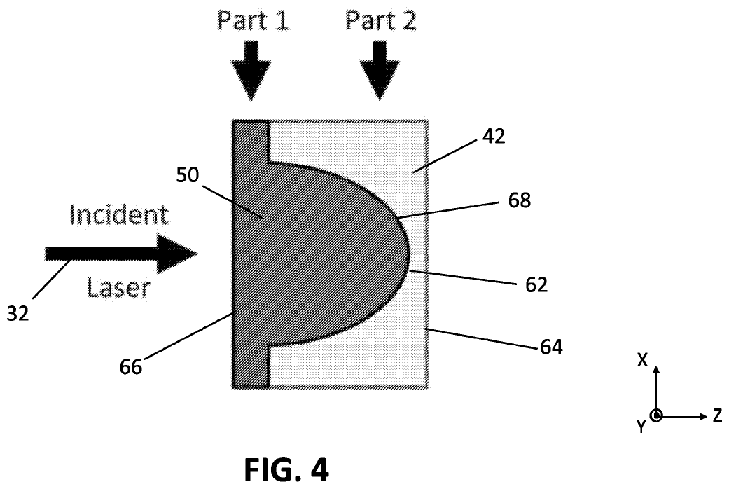

An example of a combination of the nonlinear optical element 42 and the OPD compensator 50 is shown FIG. 4. FIG. 4 is a schematic cross-sectional view and is not drawn to scale and the thickness and the shapes of the thickness variation are exaggerated and may not be the shape used. In the example shown, the nonlinear optical element 42 and/or layer of nonlinear material comprising the nonlinear optical element has a first (e.g., rear) surface 62 and second (e.g., front) surface 64 on opposite sides thereof. Similarly, the OPD compensator 50 and/or the optically transmissive material comprising the OPD compensator has a first (e.g., rear) surface 66 and second (e.g., front) surface 68 on opposite sides thereof.

In the example shown, first surface 62 of the nonlinear optical element 42 comprises a curved (e.g., concave) surface and the second surface 64 comprises a planar surface, although the shapes of the surface can be different. Also, in the example shown, the first surface 66 of the OPD compensator 50 comprises a planar surface and the second surface 68 comprises a curved (e.g., convex) surface, although the shapes of the surface can be different.

In the example shown, the nonlinear optical element 42 and the OPD compensator 50 are fit together and contact each other, for example, the first surface 62 of the nonlinear optical element is in contact with the second surface 68 of the OPD compensator, although other configurations are possible. The shape of the first surface 62 of the nonlinear optical element may be complementary to the second surface 68 of the OPD compensator 50 and vice versa in some implementations. For example, the convex second surface 68 of the OPD compensator 50 may fit conformally in the concave first surface 62 of the nonlinear optical element 42. For designs where the index of refraction of the nonlinear optical material forming the nonlinear optical element 42 is the same or as the index of refraction of the optically transmissive material forming the OPD compensator 50, the shapes of the second surface 68 of the OPD compensator and the first surface 62 of the nonlinear optical element 42 may be complementary in the case where the opposite sides both have planar surfaces 66, 64. Such an arrangement may provide a uniform optical path distance through the nonlinear optical element 42 and the OPD compensator 50 that is uniform across most or all of the area through which the laser beam passes.

In some implementations, the nonlinear optical element 42 and the OPD compensator 50 are edge-bonded together although other approaches are possible. Integrating the nonlinear optical element 42 and the OPD compensator 50 together, for example, by bonding, fusing, sealing, fitting, may provide increased protection from damage as the number and/or area of the surfaces exposed to the environment where dust or other particulates and/or contamination can be deposited, which may induce damage or cause filamentation when exposed to a high power laser beam, are reduced.

The nonlinear optical element 42 and the OPD compensator 50, however, may be spaced apart and/or the second surface 68 of the OPD compensator and the first surface 62 of the nonlinear optical element 42 may be separated by a gap. In such configurations, one or more antireflective (AR) coatings may be on the second surface 68 of the OPD compensator 50 and/or the first surface 62 of the nonlinear optical element 42 to reduce Fresnel reflection. Similarly, the second surface 64 of the nonlinear optical element 42 may contact the second surface 68 of the OPD compensator and the first surface 66 of the OPD compensator and/or the first surface 62 of the nonlinear optical element 42 may have one or more antireflective (AR) coatings thereon. Other arrangements are possible. In some configurations, possibly all the surfaces may have one or more antireflective (AR) coatings thereon. Accordingly, any combination of surfaces may have AR coatings therein. Such AR coatings may comprise one or more dielectric films or multilayers and may comprise an interference coating or multilayer in various cases.

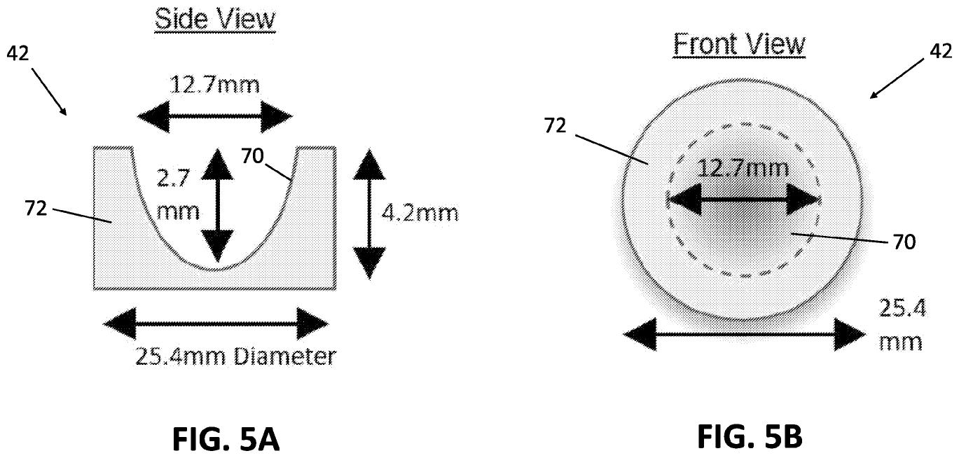

FIGS. 5A and 5B show cross-sectional and front views of the nonlinear optical element 42. These drawings of the nonlinear optical element 42 are schematic and are not drawn to scale. The thickness of the nonlinear optical element 42 as well as the shape of the first surface 62 are exaggerated and may not be the shape used. FIGS. 5A and 5B show the nonlinear optical element 42 or layer of nonlinear optical material comprising the nonlinear optical element as comprising an optical surface 70 and a flange 72. The laser beam 32 may be incident on and transmitted through the optical surface 70. The optical surface 70 may be curved as described above, to provide for a spatial variation in thickness to counter the effect of the spatially varying intensity distribution of the laser beam on the nonlinear optical medium. The flange 72 may be used for mounting the nonlinear optical element 42. As discussed above, in various implementations, the nonlinear optical element 42 may be edge bonded at the flange 72 to the OPD compensator 50 in some designs. In various implementations, the laser beam 32 does not propagate through the flange 72.

In various implementations, the nonlinear optical element 42 comprises an optical element comprising material having a nonlinear index of refraction for at least the wavelength(s) and intensity of the laser beam to which the nonlinear optical element 42 will be exposed. In some designs, the nonlinear optical material comprises plastic although in some implementations, the nonlinear optical material comprises glass such as fused silica. Other nonlinear materials may also be employed. As discussed above, in some implementations, the nonlinear material comprises allyl diglycol carbonate (CR39), which is a plastic. CR39 may exhibit both large optical nonlinearities at least when exposed to light having high intensity and is highly optically transmissive. CR39 may for example have a nonlinear refractive index, n₂, of 6.24×10⁻⁷ cm²/GW and have a 99.6% transmission after 1 mm although the parameters of the nonlinear optical element need not be so limited. In various implementations, the thickness may be 0.1 mm, 0.2 mm, 0.3 mm, 0.5 mm, 1 mm, 2 mm, 3 mm, 4 mm, 5 mm, 6 mm, 8 mm. 10 mm or in any range formed by any of these values or may be outside these ranges. (The thickness can be measured at the location corresponding to the most intense part of the beam and/or the thickness can be the average thickness.) Other plastics and other material may, however, be employed as the optically transmissive or transparent nonlinear material comprising the nonlinear optical element 42. In some implementations, the optically transmissive or transparent material used for the nonlinear optical element 42 is not optically transmissive or transparent to visible light but may be optically transmissive or transparent to other wavelengths such as infrared wavelengths.

In various implementations, the nonlinear optical element 42 is precision shaped, for example, by molding, grinding or polishing or any combination thereof. As discussed above, the thickness of the nonlinear optical element 42 and the layer of material comprising the nonlinear optical element may be small, e.g., may have an average thickness in the range from 1 mm to 5 mm. Likewise, the thickness variation may be small, e.g., from 1 μm to 1 mm, in some implementations. In various implementations, the nonlinear optical element 42 can have a maximum thickness in the range from 5 mm to 15 mm. The reduced thickness may in some cases reduce filamentation. In some implementations, the nonlinear optical element 42 can have a lateral width and/or height from 5 mm to 150 mm although the dimensions may be smaller or larger for example depending on the beam size. However, the nonlinear optical element 42 can have dimension having different sizes outside any one or more of these ranges. The dimensions shown in FIGS. 5A and 5B as well as those discussed herein should not be limiting as the dimensions may be larger or smaller.

As discussed above, the first surface 62 of the nonlinear optical element 42 may be curved and may be concave. The first surface 62 of the nonlinear optical element 42 may be rotationally symmetric. Also as discussed above, the nonlinear optical element 42 may have varying thickness and first surface 62 of the nonlinear optical element 42 may be spatially varying to provide the varying thickness such that the nonlinear optical element 42 provides a spatially varying optical nonlinearity to offset or at least partially offset the spatially varying intensity distribution 32 of the laser beam. This spatially varying thickness of the nonlinear optical element 42 and the spatially varying height or shape of the first surface 62 of the nonlinear optical element may vary based on the spatially varying intensity distribution 32 of the laser beam. Accordingly, in various implementations, the spatially varying thickness of the nonlinear optical element 42 and the spatially varying height or shape of the first surface 62 of the nonlinear optical element may be based on or change in accordance with or depend on a Gaussian and/or a Gaussian form or be a Gaussian for example, to accommodate a Gaussian laser beam. As discussed above, however, the intensity distribution of the laser and laser beam need not be Gaussian. Additionally, the shape may be, comprise or be based on a value such as the product of the thickness and intensity distribution across the cross-section of the laser beam or the portion or region of the nonlinear optical element through which the laser beam propagates. For example, in some implementations the product of the spatially varying thickness and the spatially varying intensity distribution is a constant or within a certain percentage (e.g., 50%, 40%, 30%, 20%, 10%, 5%, 4%, 3%, 2%, 1%, 0.5% or in any range formed by any of these values or outside such ranges) across the cross-section of the beam or a portion or region of the nonlinear optical element configured to receive the laser beam.

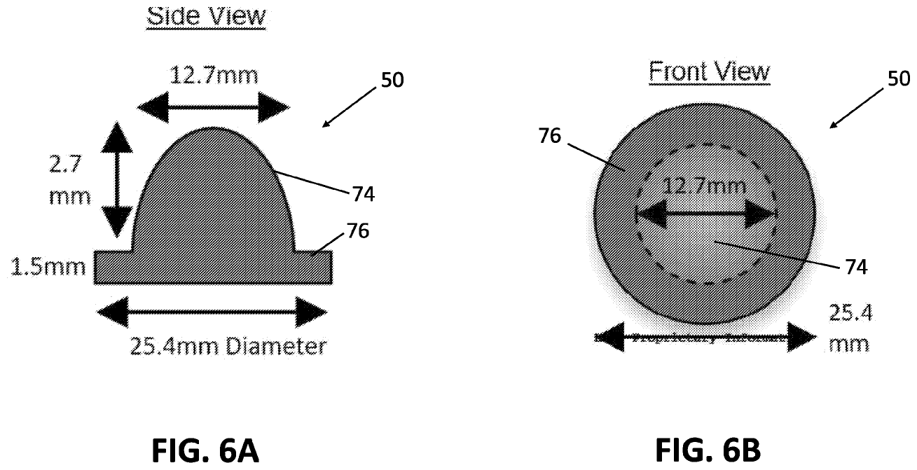

FIGS. 6A and 6B show cross-sectional and front views of the OPD compensator 50. These drawings of the OPD compensator 50 are schematic and are not drawn to scale. The thickness of the OPD compensator 50 as well as the shape of the second surface 68 are exaggerated and may not be the shape used. FIGS. 6A and 6B show the OPD compensator 50 as comprising an optical surface 74 and peripheral region 76. The laser beam 32 may be incident on and transmitted through the optical surface 74. The optical surface 74 may be curved as described above to provide for a spatial variation in thickness to counter the spatially varying optical path length through the nonlinear optical element 42 due to the spatially varying thickness of the nonlinear optical element. The peripheral region 76 may be used for mounting the OPD compensator 50. As discussed above, OPD compensator 50 may be edge bonded at the peripheral region 76 to the nonlinear optical element 42 in some designs. In various implementations, the laser beam 32 does not propagate through the peripheral region 76.

In various implementations, the OPD compensator 50 comprises an optical element having a linear refractive index and a negligible nonlinear refractive index, e.g., n₂, at the wavelength(s) and intensity of the laser beam incident thereon. In some implementations, the OPD compensator 50 comprises optically transmissive or transparent material having a linear index of refraction sufficiently close to the linear component of the refractive index of the nonlinear material comprising the nonlinear optical element although the refractive index should not be so limited and may be different from that of the nonlinear optical element. In some cases, the difference in refractive index can range from 1.4 to 1.8. In some implementations, the OPD compensator 50 comprises an optically transmissive or transparent material that is highly transmissive and has low absorption. The transmission may for example, be in the range of 95% to 100%. Likewise, in various implementations, both the linear and nonlinear absorption coefficients are low, for example less than 10 m⁻¹ for linear absorption and less than 10⁻¹⁴ m/W for nonlinear absorption. In various implementations, the OPD compensator 50 also has low optical nonlinearity, for example, the index of refraction exhibits negligible nonlinearity. The nonlinear refractive index, n₂, for example, may be less than 10⁻²⁰ m²/W for wavelengths in the range of from 400 nm to 4 μm and intensity values from 100 GW/cm² to 2 TW/cm². In various implementations, the OPD compensator 50 and the optically transmissive or transparent material comprising the OPD compensator have negligible birefringence. The OPD compensator 50 and the optically transmissive or transparent material comprising the OPD compensator may have a birefringence of not more than 1 nm/cm and may be in the range of from 0.01 nm/cm to 1 nm/cm for wavelengths in the range of from 400 nm to 4 μm and optical intensities from 100 GW/cm² to 2 TW/cm². In some designs, the OPD compensator 50 comprises plastic although in some implementations, the optically transmissive material comprises glass. Other materials may also be employed. In some implementations, the optically transmissive or transparent material used for the OPD compensator 50 may not be optically transmissive or transparent to visible light but may be optically transmissive or transparent to other wavelengths such as infrared wavelengths.

In various implementations, the OPD compensator is precision shaped, for example, by molding, grinding or polishing or any combination thereof. As discussed above, the thickness of the optical compensator 50 and the layer of material comprising the optical compensator may be small, e.g., may have an average thickness in the range from 1 mm to 5 mm. Likewise, the thickness variation may be small, e.g., from 1 μm to 1 mm. In various implementations, the OPD compensator 50 can have a maximum thickness in the range from 5 mm to 15 mm. In some implementations, the OPD compensator 50 can have a lateral width and/or height from 5 mm to 150 mm. However, the OPD compensator 50 can have dimensions having different sizes outside any one or more of these ranges. The dimensions shown in FIGS. 6A and 6B as well as those discussed herein should not be limiting as the dimensions may be larger or smaller.

In some cases, the dispersion of the nonlinear element 42 and the OPD compensator 50 may be matched to improve the compressibility of the spectrally broadened laser pulse. In various implementations, for example, the thickness of the nonlinear optical element 42 and/or OPD compensator 50 may be such that the Group Delay Dispersion (GDD) varies less than, e.g., 50%, 40%, 30%, 20%, 10%, 5%, 4%, 3%, 2%, 1% or in any range between any of these values over at least 50%, 60%, 70% 80%, 90%, 95%, 98%, 99%, or 100% of the cross-section of the beam or the portion of the nonlinear optical element 42 and/or OPD compensator 50 the laser beam that is configured to pass through or in any range between any of these values. GDD may correspond to the Group Velocity Dispersion (GVD) times the thickness.

Additionally, the surfaces of both the nonlinear element 42 and OPD compensator 50 can be AR-coated to reduce, minimize or eliminate surface reflections.

As discussed above, the second surface 68 of the OPD compensator 50 may be curved and may be convex. The second surface 68 of the OPD compensator 50 may be rotationally symmetric. Also as discussed above, the OPD compensator 50 may have varying thickness and second surface 68 of the OPD compensator 50 may vary to provide the varying thickness such that the OPD compensator 50 provides a spatially varying OPD to counter, offset, compensate for or at least partially compensate for or offset the spatially varying OPD of the nonlinear optical element 42, which also has spatially varying thickness. This spatially varying thickness of the OPD compensator 50 and the spatially varying height or shape of the second surface 68 of the OPD compensator may vary, at least indirectly, based on the spatially varying intensity distribution 32 of the laser beam. Accordingly, in various implementations the spatially varying thickness of the OPD compensator 50 and the spatially varying height or shape of the second surface 68 of the OPD compensator may be based on, depend on or change in accordance with a Gaussian and/or may have a Gaussian form or be a Gaussian for example, to accommodate a Gaussian laser beam or the resultant design shape of the nonlinear optical element 42. As discussed above, the shape of the OPD may be affected by differing indices of refraction of the nonlinear optical element 42 and the OPD compensator 50. Also as discussed above, the laser source and laser beam need not be Gaussian.

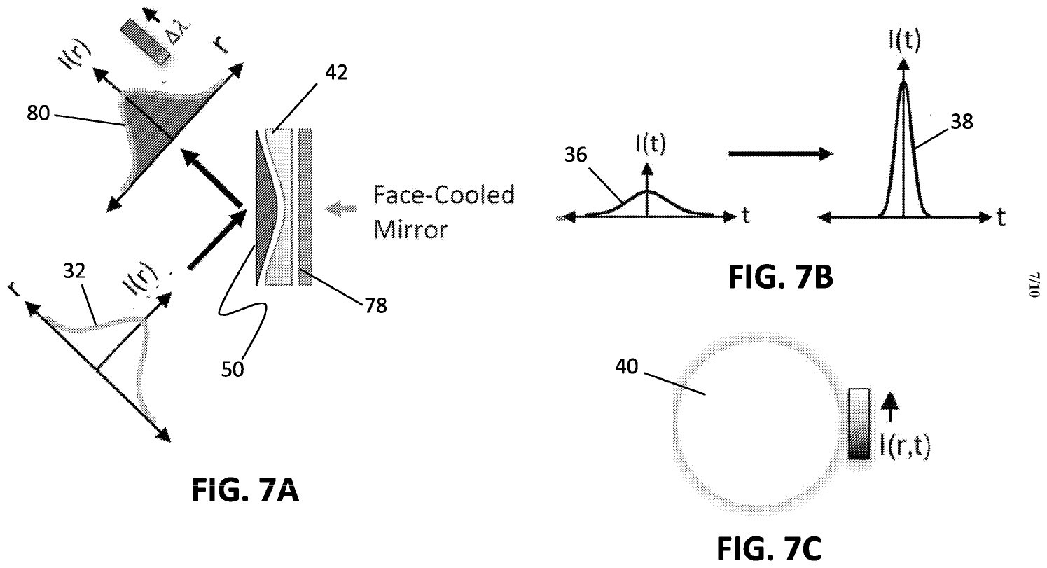

Although the nonlinear optical element 42 and the OPD compensator 50 are optically transmissive or transparent, the OPD compensator and nonlinear optical element can be paired with a reflector or mirror 78 as shown in FIG. 7A to reflect the laser beam passing through the OPD compensator and nonlinear optical element back through the OPD compensator and nonlinear optical element. The light thus passes through the nonlinear optical element 42 (and OPD compensator 50) twice, doubling the nonlinear effect or contribution. This reflector 78 may be cooled and may provide cooling to the nonlinear optical element 42 and/or the OPD compensator 50. According, the reflector or mirror 78 may therefore be referred to herein as a face cooled mirror (FCM). In various implementations, for example, one or both the nonlinear optical element 42 and OPD compensator 50 may be edge-bonded to a thin mirror 78, which may be cooled for example by being placed within a water-cooled mount. Such cooling may mitigate thermal effects and enable high pulsed laser repetition rate operation.

The reflector or mirror 78 may comprise of a glass substrate that is coated with a metal or dielectric. In some implementations, the reflector or mirror 78 is thin and may for example have a thickness between 5 mm and 10 mm. As discussed above, in some implementations, the nonlinear optical element and compensator combination can be edge-bonded to the mirror (e.g., a thin mirror). The mirror can also be cooled. For example, the mirror may be placed within a water-cooled mount. Other types of cooling may be provided for the mirror, nonlinear optical element 42, OPD compensator 50, or any combination thereof. Such cooling may provide for reduced damage and long-term stability of the optics and setup even under high repetition rate operation.

The laser beam after being propagated through the nonlinear optical element 42 and the OPD compensator 50 has the same output spatial intensity distribution 34, schematically depicted in FIG. 7A, but with a spatially homogeneously broadened output spectrum. The shading is the same under the plot 80, which according to the legend labelled 42, means that the different radial locations across the laser beam have the same number of spectral components added by the nonlinear optical element, and thus, the spectral broadening or spectral bandwidth is the same across the cross-section. This output may be nonlinearly spectrally broadened by the layer of nonlinear material comprising the nonlinear optical element 42. This laser beam can be directed to a compressor, such as a pair of chirped mirrors, to produce a compressed beam. Because the beam directed to the compressor has reduced spatio-spectral inhomogeneities (the variation in pulse duration for different locations across the cross-section of the laser beam is reduced), the laser pulse output from the compressor can be compressed, e.g., by 2-3 times or more or less, so as to produce increased intensity. FIG. 7B, for example, shows schematic plots of intensity versus time of the laser pulse 36 incident on as well as the laser pulse 38 output from the nonlinear optical element 42, OPD compensator 50, and pulse compressor (not shown). The laser pulse 38 output from the pulse compressor has increased peak intensity as a result of being compressed and having reduced spatio-spectral inhomogeneities in the nonlinearity caused by spatial inhomogeneity across the laser beam. FIG. 7C is a schematic spatio-temporal plot 40, for example, that shows spatial homogencity in temporal intensity profile (or pulse durations across the beam cross-section) of the laser pulse output by the nonlinear optical element 42, the OPD compensator 50 and pulse compressor (not shown). As illustrated, the temporal intensity profile appears uniform across the beam cross-section, consistent with homogeneous spectral broadening across the beam. Likewise, in various implementations described herein, the nonlinear optical element 42 can be shaped to reduce the deleterious effects of spatial inhomogeneities in the laser beam intensity profile and the resultant inhomogeneities in spectral broadening and the OPD compensator 50 can be configured to reduce or eliminate spatio-temporal effects arising from the shaped nonlinear optical material.

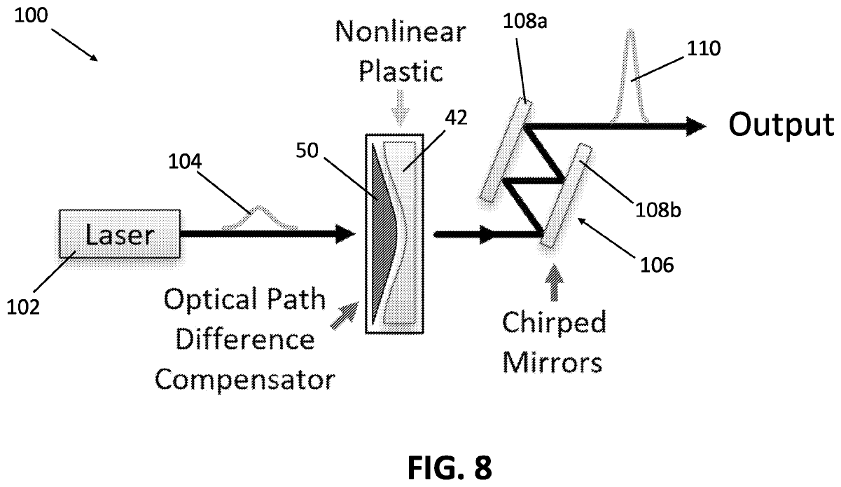

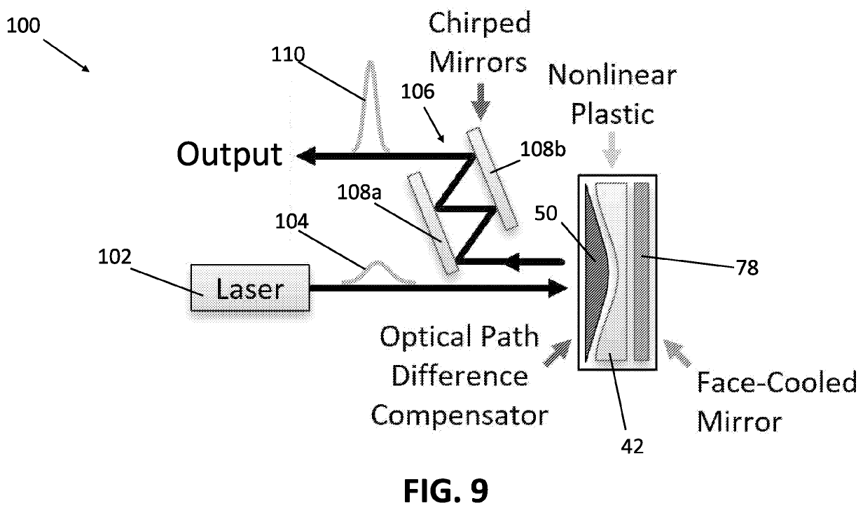

FIGS. 8-10 show different systems 100 comprising shaped nonlinear optical elements 42 and OPD compensators 50 that can provide pulse compression. FIGS. 8 and 9 both further comprise pulse compressors 106 comprising, for example, a chirped mirror pair 108a, 108b. As an alternative to the chirped mirror pair, a bulk negative dispersion compressor comprising bulk material having negative dispersion or anomalous dispersion can be employed to provide compression. Other types of compressors may possibly be employed as well. A laser source 102 is depicted outputting a laser pulse 104 that is spectrally broadened using the shaped nonlinear optical element 42 and the OPD compensator 50. The laser beam after passing through the shaped nonlinear optical element 42 and the OPD compensator 50 is compressed by the compressor 106 comprising first and second chirped mirrors 108a, 108b. A compressed pulse 110 is output by the compressor 106.

This system 100 shown in FIG. 9 further includes cooling provided by the face cooled mirror 78. This configuration, which includes the reflector 78, such as shown in FIG. 7A can facilitate providing cooling such as through a heat sink and/or cooler (e.g., water cooling etc.). This reflector 78 also provides a double pass of the laser beam and laser pulses through the shaped nonlinear optical element 42 and the OPD compensator 50.

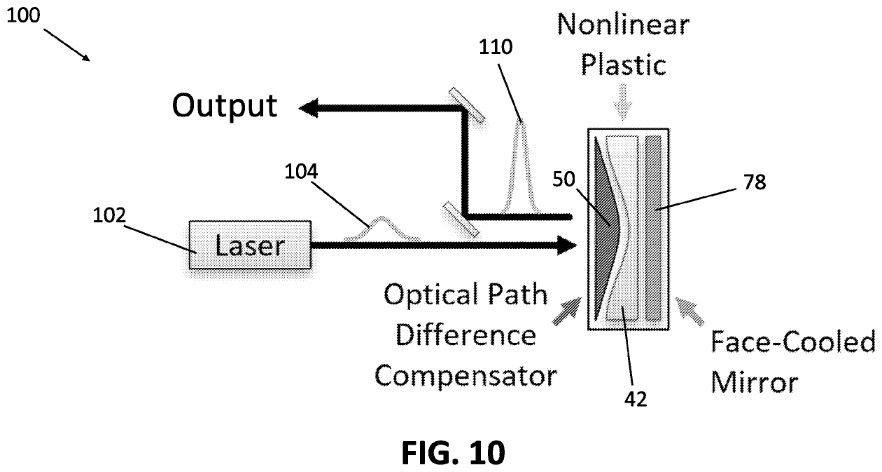

The system 100 shown in FIG. 10 provides compression using the nonlinear optical element 42 and the OPD compensator 50 via negative dispersion or anomalous dispersion which is a property of the both the nonlinear optical element and the OPD compensator at least at the wavelength(s) of the laser beam. The nonlinear optical element 42 may comprise a nonlinear medium such as plastic or glass, for example, fused silica, that has negative or anomalous dispersion at the wavelength of the laser beam. Fused silica, for example, exhibits negative dispersion at a wavelength of 2 micrometers. This negative dispersion will provide compression much like the compressors comprising the pair of chirped mirrors. Accordingly, the laser source 102 may be configured to output light at a wavelength for which the material forming the nonlinear optical element 42 and/or OPD compensator 50 have negative or anomalous dispersion. Providing a laser beam comprising such wavelengths can cause the nonlinear optical element 42 and/or OPD compensator 50 to provide pulse compression. A compressor downstream of the nonlinear optical element 42/OPD compensator 50 pair may thus be excluded and pulse compression can still be achieved. In some cases where the negative dispersion provided by the nonlinear optical element and/or the OPD compensator is not sufficient for proper (e.g., full) compression, an additional bulk plate or layer of transparent optical material with negative or positive dispersion may be added to the setup. The pulse output 110 from the nonlinear optical element 42 is thus shown in FIG. 10 as being compressed. Although including a nonlinear optical element and/or OPD compensator having negative dispersion is discussed above, the nonlinear optical element and/or OPD compensator can potentially have positive dispersion in some cases possibly to provide pulse compression.

The laser source 102 in FIGS. 8-10 may comprise a CPA system and the nonlinear optical element 42, OPD compensator 50, and compressor 106 may provide further compression, post CPA or downstream of the CPA system, thereby increasing peak intensity. The intensity is increased through the pulse compression, since the spectral broadening which provides an increase number of spectral components allows the pulse to be compressed to a shorter timescale than what would otherwise be possible. Likewise, further compression and an accompanying increase in peak intensity can be provided to a laser system such as a CPA by adding a stage comprising the shaped nonlinear optical element 42 and OPD compensator 50 described herein (with or without a separate compressor). In some situations, multiple stages (e.g., 2, 3, 4, 5, etc.), each comprising a shaped nonlinear optical element 42 and OPD compensator 50 (with or without a separate compressor) can possibly be provided for example to a laser system (e.g., to a CPA system) to provide enhancements to compression and peak intensity.

Accordingly, various designs disclosed herein include compact, inexpensive, efficient optical configurations that can be directly attached after the final laser system compressor of a CPA system to further increase the laser pulse peak power via a spatially homogenous shortening of the pulse duration. Such systems can possibly provide improved experimental capabilities for a range of laser-matter interaction investigations as well as other application.

As discussed above, after the laser pulse propagates through the devices disclosed herein, the pulse can be compressed with a chirped mirror pair 108a. 108b such as shown in FIGS. 8 and 9, bulk optical material, or pre-chirped in a compensating fashion. By exploiting the nonlinear broadening mechanism of the shaped nonlinear optical medium 42, this scalable post-CPA pulse compression technique can potentially allow for substantial peak power enhancements, and could be readily applied to real, high energy laser systems at high repetition rates. For example, a nonlinear optical element 42 such as shown in FIG. 7A comprising a layer of CR39, 1 mm thick, may provide spectral broadening via self-phase modulation in the near field (e.g., without focusing the beam on the nonlinear optical material of the nonlinear optical element) that after compression using a chirped mirror pair undergoes pulse duration shortening by a factor of 2-3 (e.g., 2.4×-3.2× pulse duration shortening) in a single pass of the optical setup for a laser beam having intensities of 1-2 TW/cm².

Accordingly, the design concepts described herein may be employed to generate nonlinear spectral broadening in bulk materials, allowing for a compressed pulse duration much shorter than that of the input pulse. Various implementations described here, for example, comprise an optical device that provides nonlinear spectral broadening of laser pulses output by a laser source. The laser source is configured to output a laser beam that propagates in a longitudinal direction and has a spatially varying intensity profile across a cross-section of the laser beam orthogonal to the longitudinal direction. The optical device comprises at least one nonlinear optical element 42 and at least one optical path difference compensator 50. The at least one nonlinear optical element 42 comprises at least one layer of material that has a nonlinear index of refraction at the intensity of the laser beam. The at least one layer of material having a nonlinear index of refraction has a spatially varying thickness that depends on the spatially varying intensity profile of the laser beam. The at least one optical path difference compensator 50 comprises at least one layer of optically transmissive material having a spatially varying thickness that varies to at least partially compensate for some of the spatially varying optical path length of said at least on nonlinear optical element. In some implementations, the at least one layer of optically transmissive material has a spatially varying thickness that varies such that the optical path length (the product of the physical distance and the index of refraction over that distance), over which the laser beam propagates through the at least one nonlinear optical element and the at least one compensator, is spatially more uniform across most of the cross-section of the laser beam.

In various implementations, the spatially varying thickness of the at least one layer of material having a nonlinear refractive index may be such that the product of this thickness and the intensity of the laser beam may be constant, for example, to within 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of the cross-section of the laser beam. Any range formed by any of the values listed above as well as values outside these ranges are also possible.

In various implementations, the spatially varying thickness of the at least one layer of material having a nonlinear refractive index may be such that the spectral broadening (e.g., at the output of the device) varies no more than 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of the cross-section of the laser beam. Any range formed by any of the values listed above as well as values outside these ranges are also possible.

In various implementations, the spatially varying thickness of the at least one layer of material having a nonlinear refractive index and the at least one layer of optically transmissive material comprising the at least one OPD compensator 50 are such that laser pulse output by a compressor downstream of the at least one nonlinear optical element and at least one OPD compensator has a duration that varies no more than 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of cross-section the laser beam is to be output. Any range formed by any of the values listed above as well as values outside these ranges are also possible.

In various implementations, the spatially varying thickness of the at least one layer of optically transmissive material comprising the at least one OPD compensator 50 is such that the optical path length (e.g., the product of the distance or thickness and the index of refraction) through the at least one layer of material having the nonlinear refractive index and the at least one layer of optically transmissive material in the at least one OPD compensator varies no more than 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of the cross-section of the laser beam. Any range formed by any of the values listed above as well as values outside these ranges are also possible. The thickness of the at least one layer of optically transmissive material comprising the at least one optical path difference compensator 50 may be such that the optical path length over which the laser beam propagates through the at least one nonlinear optical element 42 and the at least one compensator 50, is spatially more uniform across 55%, 60%, 65%, 70%, 75%, 80%, 85%, 90%, 95%, 97%, 99%, or 100% of the cross-section of the laser beam or may be in any range formed by any of these percentage values or may be outside such ranges. Spatial variation of the optical path length over which the laser beam propagates through the at least one nonlinear optical element 42 and the at least one compensator 50, may be no more than 20%, 15%, 10%, 5%, 4%, 3%, 2%, 1%, 0.5%, 0.1%, 0.01%, or 0.001% or in any range formed by any of the values. Values outside these ranges are also possible.

In various implementations, the spatially varying thickness of the at least one layer of optically transmissive material comprising the at least one OPD compensator 50 is such that the group delay through the at least one layer of material having the nonlinear refractive index and the at least one layer of optically transmissive material in the at least one OPD compensator varies no more than 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of the cross-section the laser beam. Any range formed by any of the values listed above as well as values outside these ranges are also possible.

In various implementations, the spatially varying thickness of the at least one layer of optically transmissive material comprising the at least one OPD compensator 50 is such that the group delay between different portions across 50%, 60%, 70%, 80%, 90%, 95%, 96%, 97%, 98%, 99%, 99.9%, or 100% of the cross-section of a pulse output by the device are no more than 50%, 40%, 30%, 20%, 10%, 5%, 4%, 2%, 1%, 0.5%, or 0.1% of the pulse duration. Any range formed by any of the values listed above as well as values outside these ranges are also possible.

In various implementations, the spatially varying thickness of the at least one layer of optically transmissive material comprising the at least one OPD compensator 50 is such that the group delay dispersion (e.g., the group velocity dispersion times the total thickness of the at least one layer of material having the nonlinear refractive index and the at least one layer of optically transmissive material in the at least one OPD compensator) through the at least one layer of material having the nonlinear refractive index and the at least one layer of optically transmissive material in the at least one OPD compensator varies by no more than 50%, 40%, 30%, 20%, 10%, 5%, 4%, 2%, 1%, 0.5%, or 0.1% across at least 50%, 60%, 70%, 80%, 90%, 95%, 96%, 97%, 98%, 99%, 99.9%, or 100% of the cross-section of the laser beam. Any range formed by any of the values listed above as well as values outside these ranges are also possible.

The direct application of various designs disclosed herein may be included to provide an existing laser system with the capability to shorten the pulse duration and therefore directly increase the peak power, while maintaining the overall system efficiency and repetition rate. Various implementations are particularly well-suited for large mode area, high energy ultrashort laser systems. The strong spectral broadening induced within devices discussed herein may allow the end-user to bypass gain-narrowing limitations often incurred within high peak power laser setups containing multi-pass or regenerative amplifiers. The spectral broadening could also be beneficial at either or both the input and output of frequency conversion schemes (e.g., second harmonic generation, optical parametric amplification, etc.). Additionally, the pulse duration reduction provided by various devices described herein can also enhance performance of ultrashort laser systems, which may be used for experiments such as for high intensity laser-matter investigations (e.g., laser-plasma wakefield acceleration of electrons).

A wide variety of variations in device, system and subsystem designs and methods of use are possible. For example, although some devices may include only a single nonlinear optical element and only a single OPD compensator, other devices may comprise more than one nonlinear optical element or more than one OPD compensator or more than one nonlinear optical element and more than one OPD compensator. For example, a nonlinear optical element may be sandwiched between a pair of OPD compensators. Alternatively, an OPD compensator may be sandwiched between a pair of nonlinear optical elements. Similarly, more than one layer of material having a nonlinear refractive index may be included in a nonlinear optical element. Different nonlinear optical elements in the device may comprise the same or different material having the same or different refractive indices. The different layers of material having a nonlinear refractive index may comprise the same or different material having the same or different refractive indices. Likewise, more than one layer of optically transmissive material may be included in an OPD compensator. Different OPD compensators in the device may comprise the same or different material having the same or different refractive indices. The different layers of optically transmissive material can comprise the same or different material having the same or different refractive indices. Additionally, one or more additional layers of material that have a non-linear refractive index and/or one or more additional layers of optically transmissive material may be included in the device, the thickness of which can be varying or non-varying. Accordingly, any of the features, characteristics, properties, arrangements, and/or designs of the nonlinear optical element and/or the OPD compensator described herein may be applicable to multiple nonlinear optical elements and/or multiple OPD compensators as well as possibly to one or more additional layers of material that have a non-linear refractive index and/or one or more additional layers of optically transmissive material that may be included in the device. Moreover, any of the features described herein can be combined with any other features described herein. Other variations are possible.

### Examples

This disclosure provides various examples of devices, systems, and subsystems. Some such examples include but are not limited to the following examples.

1. An optical device for providing nonlinear spectral broadening of laser pulses output by a laser source, said laser source configured to output a laser beam that propagates in a longitudinal direction and has a spatially varying intensity profile across a cross-section of the laser beam orthogonal to the longitudinal direction, said optical device comprising:
at least one nonlinear optical element comprising at least one layer of material that has a nonlinear index of refraction at the intensity of the laser beam, the at least one layer of material having a nonlinear index of refraction having a spatially varying thickness that depends on the spatially varying intensity profile of the laser beam; and
at least one optical path difference compensator comprising at least one layer of optically transmissive material having a spatially varying thickness that varies to at least partially compensate for at least some of the spatially varying optical path length of said at least one nonlinear optical element.

2. The optical device of Example 1, wherein said at least one layer of optically transmissive material has a spatially varying thickness that varies such that the optical path length over which the laser beam propagates through the at least one nonlinear optical element and the at least one compensator is spatially more uniform across most of the cross-section of the laser beam.

3. The optical device of Example 1 or 2, wherein at least one layer of material having a nonlinear index of refraction has a concave surface.

4. The optical device of Example 3, wherein at least one layer of optically transmissive material comprising said at least one optical path difference compensator has a convex surface.

5. The optical device of Example 4, wherein said concave surface and said convex surface are complementary such that said convex surface fits conformally within said concave surface.

6. The optical device of any of the Examples above, wherein said at least one layer of material having a nonlinear index of refraction and said at least one layer of optically transmissive material are attached together.

7. The optical device of any of the Examples above, wherein said at least one layer of material having a nonlinear index of refraction and said at least one layer of optically transmissive material are edge bonded together.

8. The optical device of any of the Examples above, wherein at least one layer of said optically transmissive material comprising said optical path difference compensator has a thickness profile that is Gaussian.

9. The optical device of any of the Examples above, wherein said material having a nonlinear refractive index at said intensity of said laser beam in at least one layer of material in said at least one nonlinear optical element comprises plastic.

10. The optical device of any of the Examples above, wherein said material having a nonlinear refractive index at said intensity of said laser in at least one layer of material in said at least one nonlinear optical element comprises CR39.

11. The optical device of any of the Examples above, wherein said at least one layer of material having a nonlinear refractive index at said intensity of said laser has an average thickness in the range from 1 mm to 5 mm.

12. The optical device of any of the Examples above, wherein the optically transmissive material comprising said at least one layer of optically transmissive material comprising said at least one optical path difference compensator has negligible birefringence.

13. The optical device of any of the Examples above, wherein said optically transmissive material comprising said at least one layer of optically transmissive material comprising said at least one optical path difference compensator has a birefringent of no more than 1 nm/cm.

14. The optical device of any of the Examples above, wherein said optically transmissive material comprising at least one layer of optically transmissive material comprising said at least one optical path difference compensator has a negligible linear absorption and a negligible nonlinear absorption.

15. The optical device of any of the Examples above, wherein said optically transmissive material comprising at least one layer of optically transmissive material comprising said at least one optical path difference compensator has a linear absorption of no more than 10 m⁻¹ and a nonlinear absorption of no more than 10⁻¹⁴ m/W.

16. The optical device of any of the Examples above, wherein said optically transmissive material comprising at least one layer of optically transmissive material comprising said at least one optical path difference compensator has negligible optical nonlinearity.

17. The optical device of any of the Examples above, wherein said optically transmissive material comprising at least one layer of optically transmissive material comprising said at least one optical path difference compensator has negligible coefficient of optical nonlinearity, n₂.

18. The optical device of any of the Examples above, further comprising a reflector disposed with respect to said at least one nonlinear optical element and said at least one optical path difference compensator such that light incident on and propagating through said at least one nonlinear optical element and said at least one optical path difference compensator reflects from said reflector and propagates again through said at least one nonlinear optical element and said at least one optical path difference compensator.

19. The optical device of Example 18, wherein said at least one nonlinear optical element is between said at least one optical path difference compensator and said reflector.

20. The optical device of Example 18 or 19, wherein said reflector is configured to configured to cool said at least one nonlinear optical element and/or said at least one optical path difference compensator.

21. The optical device of any of the Examples above, further comprising a pulse compressor disposed to receive said laser beam after passing through said at least one nonlinear optical element and said at least one optical path difference compensator.

22. The optical device of Example 21, wherein said pulse compressor comprises a pair of chirped mirrors.

23. The optical device of any of the Examples above, wherein said laser beam is output from a pulse amplification system.

24. The optical device of any of the Examples above, wherein said at least one nonlinear optical element and/or said at least one OPD compensator has positive or negative dispersion at the wavelengths of said laser beam such that said at least one nonlinear optical element and/or at least one OPD compensator provides pulse compression.

25. The optical device of any of the Example 24, wherein said laser beam comprises a wavelength in the range of 1.3 microns and 4 microns.

26. The optical device of any of the Examples above, wherein said laser beam comprises a wavelength in the range of 400 nm and 4 microns.

27. The optical device of any of the Examples above, wherein the product of the thickness of the at least one layer of material having a nonlinear refractive index and the intensity of the laser beam are constant to within 1% across most of the cross-section of the laser beam.

28. The optical device of any of the Examples above, wherein the product of the thickness of the at least one layer of material having a nonlinear refractive index and the intensity of the laser beam are constant to within 5% across at least 90% of the cross-section of the laser beam.

29. The optical device of any of the Examples above, wherein the spatially varying thickness of the at least one nonlinear optical element is such that spectral broadening produced by the at least one nonlinear optical element varies by no more than 1% across the majority of the cross-section of the laser beam.

30. The optical device of any of the Examples above, wherein the spatially varying thickness of the at least one nonlinear optical element is such that spectral broadening produced by the at least one nonlinear optical element varies by no more than 5% across at least 90% of the cross-section of the laser beam.

31. The optical device of any of the Examples above, wherein the spatially varying thickness of the at least one nonlinear optical element and the at least one OPD compensator are such that pulse output from the device has a duration that varies by no more than 1% across the majority of the cross-section of the laser beam.

32. The optical device of any of the Examples above, wherein the spatially varying thickness of the at least one nonlinear optical element and the at least one OPD compensator are such that pulse output from the device has a duration that varies by no more than 5% across at least 90% of the cross-section of the laser beam.

33. The optical device of any of the Examples above, wherein the spatially varying thickness of the at least one layer of optically transmissive material in the at least one OPD compensator is such that the optical path length through the at least one layer of material having the nonlinear refractive index and the at least one layer of optically transmissive material in the at least one OPD compensator varies by no more than 1% across the majority of the cross-section of the laser beam.

34. The optical device of any of the Examples above, wherein the spatially varying thickness of the at least one layer of optically transmissive material in the at least one OPD compensator is such that optical path length through the at least one layer of material having the nonlinear refractive index and the layer of optically transmissive material in the at least one OPD compensator varies by no more than 5% across at least 90% of the cross-section of the laser beam.

35. The optical device of any of the Examples above, wherein the spatially varying thickness of at least one layer of optically transmissive material comprising the at least one OPD compensator is such that the group delay through the at least one layer of material having the nonlinear refractive index and the at least one layer of optically transmissive material in the at least one OPD compensator varies by no more than 1% across the majority of the cross-section of the laser beam.

36. The optical device of any of the Examples above, wherein the spatially varying thickness of the at least one layer of optically transmissive material in the at least one OPD compensator is such that the group delay through the at least one layer of material having the nonlinear refractive index and the at least one layer of optically transmissive material in the at least one OPD compensator varies by no more than 5% across at least 90% of the cross-section of the laser beam.

37. The optical device of any of the Examples above, wherein the spatially varying thickness of the at least one layer of optically transmissive material of the at least one OPD compensator is such that the group delay between different portions across the majority of the cross-section of a pulse output by the device are no more than 50% the pulse duration.

38. The optical device of any of the Examples above, wherein the spatially varying thickness of the at least one layer of optically transmissive material of the at least one OPD compensator is such that the group delay between different portions of the majority of the cross-section of a pulse output by the device are no more than 30% the pulse duration.

39. The optical device of any of the Examples above, wherein the spatially varying thickness of the at least one layer of optically transmissive material of the at least one OPD compensator is such that the group delay between different portions of the majority of the cross-section of a pulse output by the device are no more than 10% the pulse duration.

40. The optical device of any of the Examples above, wherein the spatially varying thickness of the at least one layer of optically transmissive material comprising the at least one OPD compensator is such that the group delay dispersion through the at least one layer of material having the nonlinear refractive index and the at least one layer of optically transmissive material in the at least one OPD compensator varies by no more than 1% across the majority of the cross-section of the laser beam.

41. The optical device of any of the Examples above, wherein the spatially varying thickness of the at least one layer of material comprising the at least one OPD compensator is such that the group delay dispersion through the at least one layer of material having the nonlinear refractive index and the at least one layer of optically transmissive material in the at least one OPD compensator varies by no more than 5% across at least 90% of the cross-section of the laser beam.

42. The optical device of any of the Examples above, wherein said at least one nonlinear optical element comprises a plurality of nonlinear optical elements.

43. The optical device of any of the Examples above, different nonlinear optical elements comprise different material.

44. The optical device of any of the Examples above, different nonlinear optical elements comprise the same material.

45. The optical device of any of the Examples above, different nonlinear optical elements have different indices of refraction.

46. The optical device of any of the Examples above, different nonlinear optical elements have the same index of refraction.

47. The optical device of any of the Examples above, wherein said at least one layer of material that has a nonlinear index of refraction comprises a plurality of layers of material having nonlinear indices of refraction, different layers of said plurality of layers having nonlinear indices of refraction comprising different material.

48. The optical device of any of the Examples above, wherein said at least one layer of material that has a nonlinear index of refraction comprises a plurality of layers of material having nonlinear indices of refraction, different layers of said plurality of layers having nonlinear indices of refraction comprising the same material.

49. The optical device of any of the Examples above, wherein said at least one layer of material that has a nonlinear index of refraction comprises a plurality of layers of material having nonlinear indices of refraction, different layers of said plurality of layers having nonlinear indices of refraction having different refractive indices.

50. The optical device of any of the Examples above, wherein said at least one layer of material that has a nonlinear index of refraction comprises a plurality of layers of material having nonlinear indices of refraction, different layers of said plurality of layers having nonlinear indices of refraction having the same refractive index.

51. The optical device of any of the Examples above, wherein said at least one OPD compensator comprises a plurality of OPD compensators.

52. The optical device of any of the Examples above, different OPD compensators comprise different material.

53. The optical device of any of the Examples above, different OPD compensators comprise the same material.

54. The optical device of any of the Examples above, different OPD compensators have different indices of refraction.

55. The optical device of any of the Examples above, different OPD compensators have the same index of refraction.

56. The optical device of any of the Examples above, wherein said at least one layer of optically transmissive material in said OPD compensator comprises a plurality of layers of optically transmissive material, different layers of said plurality of optically transmissive material comprising different optically transmissive material.

57. The optical device of any of the Examples above, wherein said at least one layer of optically transmissive material in said OPD compensator comprises a plurality of layers of optically transmissive material, different layers of said plurality of optically transmissive material comprising the same optically transmissive material.

58. The optical device of any of the Examples above, wherein said at least one layer of optically transmissive material in said OPD compensator comprises a plurality of layers of optically transmissive material, different layers of said plurality of layers of optically transmissive material having different refractive indices.

59. The optical device of any of the Examples above, wherein said at least one layer of optically transmissive material in said OPD compensator comprises a plurality of layers of optically transmissive material, different layers of said plurality of layers of optically transmissive material having the same refractive index.

60. The optical device of any of the Examples above, wherein said laser beam comprises a Gaussian laser beam and said spatially varying intensity profile of said laser beam is a Gaussian distribution

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. An optical device for providing nonlinear spectral broadening of laser pulses output by a laser source, said laser source configured to output a laser beam that propagates in a longitudinal direction and has a spatially varying intensity profile across a cross-section of the laser beam orthogonal to the longitudinal direction, said optical device comprising:
at least one nonlinear optical element comprising at least one layer of material that has a nonlinear index of refraction at the intensity of the laser beam, the at least one layer of material having a nonlinear index of refraction having a spatially varying thickness that depends on the spatially varying intensity profile of the laser beam; and
at least one optical path difference compensator comprising at least one layer of optically transmissive material having a spatially varying thickness that varies to at least partially compensate for at least some of the spatially varying optical path length of said at least on nonlinear optical element.

2. The optical device of claim 1, wherein said at least one layer of optically transmissive material has a spatially varying thickness that varies such that the optical path length over which the laser beam propagates through the at least one nonlinear optical element and the at least one compensator is spatially more uniform across most of the cross-section of the laser beam.

3. The optical device of claim 1, wherein said material having a nonlinear refractive index at said intensity of said laser beam in at least one layer of material in said at least one nonlinear optical element comprises plastic.

4. The optical device of claim 1, wherein said material having a nonlinear refractive index at said intensity of said laser in at least one layer of material in said at least one nonlinear optical element comprises CR39.

5. The optical device of claim 1, wherein said at least one layer of material having a nonlinear refractive index at said intensity of said laser has an average thickness in the range from 1 mm to 5 mm.

6. The optical device of claim 1, wherein said optically transmissive material comprising said at least one optical path difference compensator has negligible birefringence.

7. The optical device of claim 1, wherein said optically transmissive material comprising said at least one optical path difference compensator has a birefringent of no more than 1 nm/cm.

8. The optical device of claim 1, wherein said optically transmissive material comprising said at least one optical path difference compensator has a negligible linear absorption and a negligible nonlinear absorption.

9. The optical device of claim 1, wherein said optically transmissive material comprising said at least one optical path difference compensator has a linear absorption of no more than 10 m⁻¹ and a nonlinear absorption of no more than 10⁻¹⁴ m/W.

10. The optical device of claim 1, wherein said optically transmissive material comprising said at least one optical path difference compensator has negligible optical nonlinearity.

11. The optical device of claim 1, wherein further comprising a reflector disposed with respect to said at least one nonlinear optical element and said at least one optical path difference compensator such that light incident on and propagating through said at least one nonlinear optical element and said at least one optical path difference compensator reflects from said reflector and propagates again through said at least one nonlinear optical element and at least one said optical path difference compensator.

12. The optical device of claim 11, wherein said at least one nonlinear optical element is between said at least one optical path difference compensator and said reflector.

13. The optical device of claim 11, wherein said reflector is configured to configured to cool said at least one nonlinear optical element and/or said at least one optical path difference compensator.

14. The optical device of claim 1, further comprising a pulse compressor disposed to receive said laser beam after passing through said at least one nonlinear optical element and said at least one optical path difference compensator.

15. The optical device of claim 14, wherein said pulse compressor comprises a pair of chirped mirrors.

16. The optical device of claim 1, wherein said laser beam is output from a chirped pulse amplification system.

17. The optical device of claim 1, wherein said at least one nonlinear optical element and/or said at least one OPD compensator has dispersion at the wavelengths of said laser beam such that said at least one nonlinear optical element and/or said at least one OPD compensator provides pulse compression.

18. The optical device of claim 1, wherein said at least one layer of material that has a nonlinear index of refraction comprises a plurality of layers of material having nonlinear indices of refraction, different layers of said plurality of layers having nonlinear indices of refraction comprising different material.

19. The optical device of claim 1, wherein said at least one layer of optically transmissive material in said OPD compensator comprises a plurality of layers of optically transmissive material, different layers of said plurality of optically transmissive material comprising different optically transmissive material.
